(19) United States
(12) Patent Application Publication
(10) Pub. No.: US 2006/0187373 A1
(43) Pub. Date: Aug. 24, 2006

(54) Liquid crystal display module with frame having point light source fixed therein

(75) Inventor: Guo-Liang Hu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/356,815

(22) Filed: Feb. 17, 2006

(30) Foreign Application Priority Data
Feb. 18, 2005 (CN) 200520054959X

(51) Int. Cl. G02F 1/1333

(52) U.S. Cl. 349/58

(57) ABSTRACT

An LCD module (2) includes a frame (210) having a plurality of side walls (212) which cooperatively defining a containing space (211), one of the side walls defines a slot (213) and two rib portions (214, 215) bounding the slot, one of the rib portions is adjacent to the containing space and defines at least one gap (216) therein; a light guide plate (220) having a light incident surface, one or more optical sheets (230, 240, 250), and an LCD panel (260) disposed in the containing space; a circuit board (270) electrically connecting to the liquid crystal display panel; and at least one point light source (280) attached at the circuit board and being adjacent to the light guide plate. The point light source is received in the gap and interferentially received in the slot between the rib portions.

### FIELD OF THE INVENTION

The present invention relates to electronic display modules, and more particularly to a liquid crystal display module with a frame for arranging one or more point light sources such as light emitting diodes or the like.

### BACKGROUND

Liquid crystal display (LCD) devices have been widely used in notebooks, personal digital assistants (PDAs), cellular phones, and other electronic products because the price of LCDs is low and the quality of LCDs is high. LCDs are passive optical devices. Therefore a frontlight module or a backlight module needs to be attached to the LCD panel, in order to provide sufficient illumination to make the display of the LCD panel visible at night and to provide a full color display. Generally, the backlight module includes a light source and a diffusion sheet. The diffusion sheet is usually attached below the LCD panel, in order to disperse light beams received from the light source and provide uniform light for the LCD panel. The uniform light enables the LCD panel to display a clear image.

The light source of contemporary backlight modules is usually one of two types: a cold cathode fluorescent lamp (CCFL), or a light emitting diode (LED). The luminescent efficiency of the CCFL is relatively high. However, the the CCFL is usually large, and the CCFL consumes more electricity. Therefore, the CCFL is generally only suitable for a large-sized multicolor display requiring high brightness levels. In contrast, the luminescent efficiency of the LED is lower, the size of the LED is smaller, the emitted light of the LED is more focused, and the working lifetime of the LED is longer. In addition, even when the LED wears out and is discarded, the LED causes less pollution. Therefore, the LED is suitable for a monochromatic, electrically efficient, small sized product, such as an LCD panel used in a cellular phone or in a vehicular satellite navigation system.

Referring to FIG. 6, a conventional LCD module 1 includes a reflector 190, a frame 110, a light guide plate 120, a diffusion sheet 130, a first prism sheet 140, a second prism sheet 150, and an LCD panel 160, arranged in that order from bottom to top.

The frame 110 includes four side walls (not labeled), which cooperate with each other to form a rectangular housing having a central containing space 111. One of the side walls defines a long slot 112 therein. The LCD panel 160 is electrically connected to an FPCB (flexible printed circuit board) 170, and three point light sources 180 are attached to the FPCB 170. The point light sources 180 are light emitting diodes.

In assembly, the light guide plate 120, the diffusion sheet 130, the first and the second prism sheets 140, 150, and the LCD panel 160 are received in the containing space 111 of the frame 110. The reflector 190 is attached to a bottom surface of the light guide plate 120. The FPCB 170 is flexed and inserted through the slot 112, and is then folded over and fixed to a bottom of the reflector 190. After such assembly, the point light sources 180 are located in the slot 112, so that they can emit light beams into the light guide plate 120. The light beams eventually propagate through the prism sheets 140, 150 to illuminate the LCD panel 160.

However, the point light sources 180 are generally only located in the slot 112 without being fixed in position. The point light sources 180 are liable to be displaced if the LCD module 1 encounters vibration or shock. If the point light sources 180 are displaced, some of the light beams emitted therefrom are liable to be lost. This in turn diminished the display characteristics of the LCD module 1.

### SUMMARY

Provided is an LCD module, which includes a frame having a plurality of side walls which cooperatively defining a containing space, one of the side walls defines a slot and two rib portions bounding the slot, one of the rib portions is adjacent to the containing space and defines at least one gap therein; a light guide plate having a light incident surface, one or more optical sheets, and an LCD panel disposed in the containing space; a circuit board electrically connecting to the liquid crystal display panel; and at least one point light source attached at the circuit board and being adjacent to the light guide plate. The point light source is received in the gap and interferentially received in the slot between the rib portions.

With this configuration, the point light sources are resiliently pressed by the rib portions, and are thus stably held in the slot of the side wall. The point light sources resist displacement if the LCD module encounters vibration or shock. Moreover, the point light sources are disposed adjacent to the light incident surface of the light guide plate. Therefore most if not all of the light beams emitted by the point light sources enter the light guide plate. This enables the LCD module to have high brightness and good display characteristics.

Other advantages and novel features will become more apparent from the following detailed description when taken in conjunction with the accompanying drawings.

### BRIEF DESCRIPTION OF THE DRAWINGS

FIG. 1 is an exploded, isometric view of an LCD module according to a preferred embodiment of the present invention.

FIG. 2 is a partially assembled view of the LCD module of FIG. 1, showing an FPCB thereof only partially assembled.

FIG. 3 is a fully assembled view of the LCD module of FIG. 1.

FIG. 4 is an enlarged, cutaway view of part of the LCD module shown in FIG. 3, corresponding to line IV-IV thereof.

FIG. 5 is a side view of the part of the LCD module shown in FIG. 4.

FIG. 6 is an exploded, isometric view of a conventional LCD module.

### DETAILED DESCRIPTION OF PREFERRED EMBODIMENTS

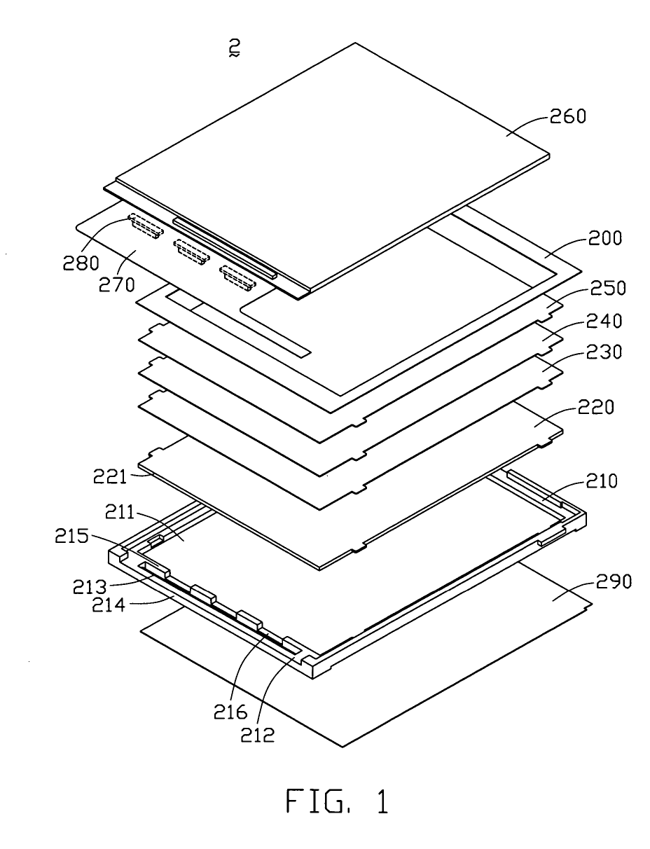

Referring to FIG. 1, an LCD module 2 according to a preferred embodiment of the present invention includes a reflector 290, a frame 210, a light guide plate 220, a diffusion sheet 230, a first prism sheet 240, a second prism sheet 250, a shielding belt 200, and an LCD panel 260, disposed in that order from bottom to top. The LCD module 2 further includes a FPCB (flexible printed circuit board) 270 and three point light sources 280. The FPCB 270 is disposed adjacent to and is electrically connected to one side of the LCD panel 260. The point light sources 280 are arranged in a line, and are attached to the FPCB 270. In this embodiment, the point light sources 280 are light emitting diodes (LEDs).

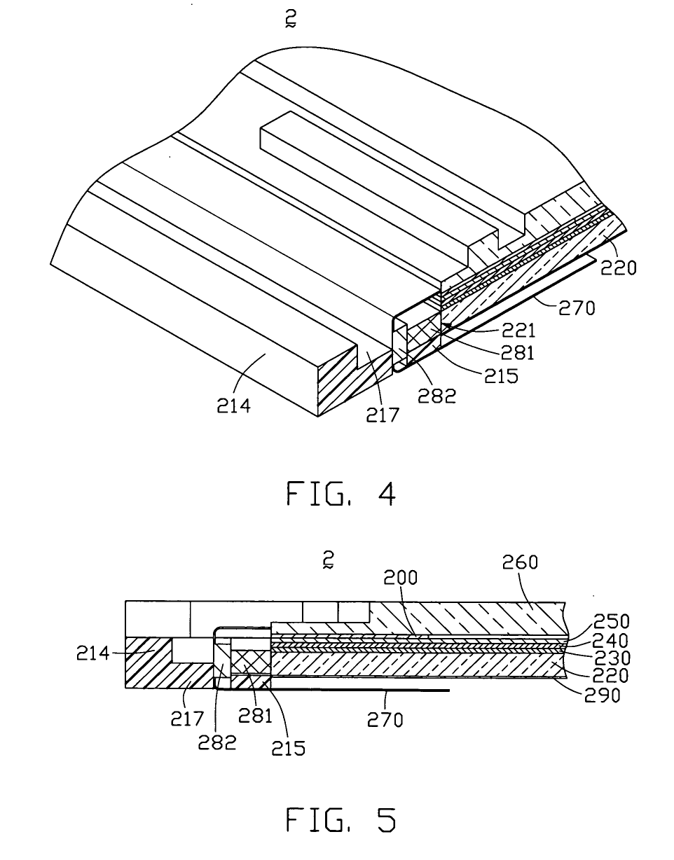

The frame 210 includes four side walls 212, which cooperate with each other to form a rectangular housing having a central containing space 211. The side wall 212 corresponding to the FPCB 270 defines a long slot 213, and two rib portions 214, 215 bounding opposite long sides of the slot 213 respectively. The rib portion 215 is adjacent to the containing space 211. The rib portion 215 defines three separate gaps 216 therein, corresponding to the point light sources 280. The rib portion 214 defines a step portion 217 (best seen in FIG. 4) facing the rib portion 215 across the slot 213. The light guide plate includes a light incident surface 221.

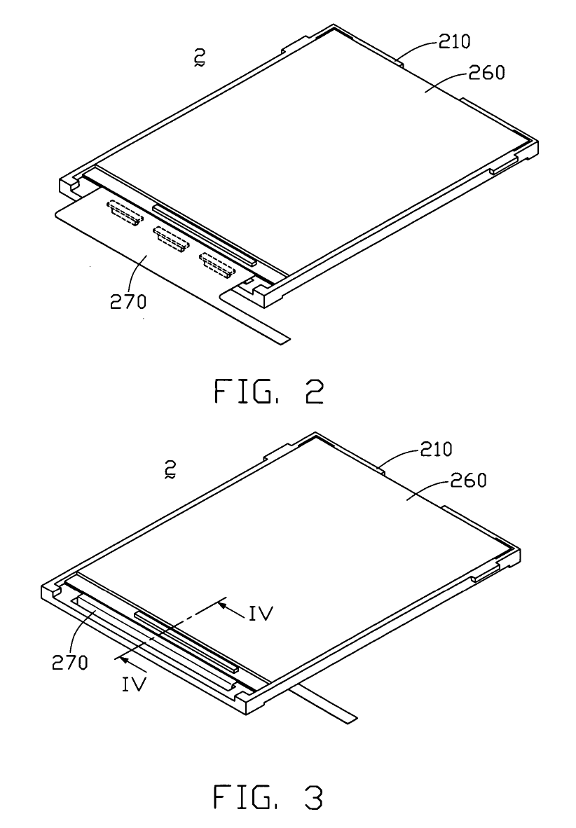

Also referring to FIG. 2, in assembly, the light guide plate 220, the diffusion sheet 230, the first and the second prism sheets 240, 250, the shielding belt 200, and the LCD panel 260 are received in the containing space 211 of the frame 210 in that order. The reflector 290 is attached to a bottom surface (not labeled) of the light guide plate 220. Also referring to the FIG. 3, the FPCB 270 is flexed and inserted through the slot 213, and is then deflexed and fixed to a bottom of the reflector 290. The step portion 217 of the rib portion 214 enables the FPCB 270 and the point light sources 280 to be more easily inserted into the slot 213.

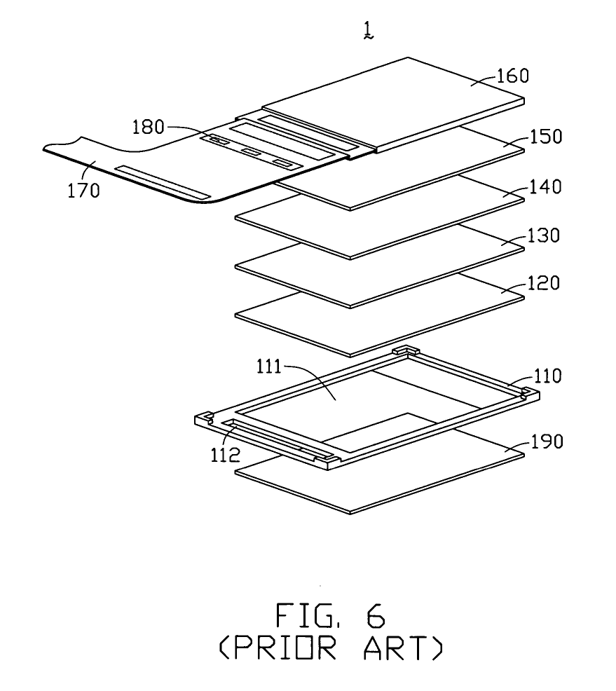

FIG. 4 is an enlarged, cutaway view of part of the LCD module 2 shown in FIG. 3, corresponding to line IV-IV thereof FIG. 3. FIG. 5 is a side view of the part of the LCD module 2 shown in FIG. 4. After assembly, the point light sources 280 are engaged in the slot 213 and the gaps 216 of the corresponding side wall 212. Each point light source 280 includes a light emitting portion 281 received in a corresponding gap 216, and a driving portion 282 interferentially received in the slot 213 between the rib portions 214, 215. The light emitting portions 281 are thus adjacent to the light incident surface 221 of the light guide plate 220.

In operation, the FPCB 270 drives the point light sources 280 to emit light beams, and the light beams enter the light guide plate 220 through the light incident surface 221. The light beams are transmitted within the light guide plate 220 and/or reflected by the reflector 290, and are collectively converted to a surface light source outputting light from a top surface of the light guide plate 220. The output light beams pass through the diffusion sheet 230 and the prism sheets 240, 250, and thus illuminate the LCD panel 260.

With this configuration, the point light sources 280 are resiliently pressed by the rib portions 214, 215, and are thus stably held in the slot 213 of the side wall 212. The point light sources 280 resist displacement if the LCD module 2 encounters vibration or shock. Moreover, the light emitting portions 281 of the point light sources 280 are stably positioned adjacent to the light incident surface 221 of the light guide plate 220. Therefore most if not all of the light beams emitted by the point light sources 280 enter the light guide plate 220. This enables the LCD module 2 to have high brightness and good display characteristics.

Various modifications and alterations are possible within the scope of the preferred embodiment herein. For example, the FPCB 270 may include one or more rigid circuit regions for attachment of the point light sources 280 thereto. The rigid circuit regions have a rigidity greater than that of other flexible regions of the FPCB 270. This enables the point light sources 280 to be more tightly and accurately positioned in the frame 210 of the LCD module 2.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display module, comprising:
a frame comprising a plurality of side walls, the side walls cooperatively defining a containing space, one of the side walls defining a slot and two rib portions bounding the slot, one of the rib portions being adjacent to the containing space and defining at least one gap therein;
a light guide plate having a light incident surface, the light guide plate being disposed in the containing space;
one or more optical sheets disposed on the light guide plate;
a liquid crystal display panel disposed on the optical sheets;
a circuit board electrically connecting to the liquid crystal display panel; and
at least one point light source attached at the circuit board and being adjacent to the light incident surface of the light guide plate, the point light source being received in the gap and interferentially received in the slot between the rib portions.

2. The liquid crystal display module as claimed in claim 1, wherein the at least one gap is a plurality of separate gaps, and the at least one point light source is a plurality of separate point light sources received in the gaps.

3. The liquid crystal display module as claimed in claim 1, wherein the point light source comprises a light emitting portion received in the gap, and a driving portion resiliently pressed by the rib portions.

4. The liquid crystal display module as claimed in claim 1, wherein the other rib comprises a step portion.

5. The liquid crystal display module as claimed in claim 1, wherein the circuit board is a flexible circuit board, and is partially received in the slot.

6. The liquid crystal display module as claimed in claim 1, wherein the circuit board comprises at least one rigid circuit region having the at least one light source attached thereto.

7. The liquid crystal display module as claimed in claim 1, wherein the optical sheets comprise items selected from the group consisting of a diffusion sheet, a first prism sheet, and a second prism sheet.

8. The liquid crystal display module as claimed in claim 1, wherein the point light source is a light emitting diode.

9. The liquid crystal display module as claimed in claim 1, further comprising a reflector attached to a bottom surface of the light guide plate.

10. The liquid crystal display module as claimed in claim 1, further comprising a shielding belt disposed between the optical sheets and the liquid crystal panel.
